(19) United States
(12) Patent Application Publication
(10) Pub. No.: US 2024/0186941 A1
(43) Pub. Date: Jun. 6, 2024

(54) SHADING MITIGATION FOR PHOTOVOLTAIC ARRAYS

(71) Applicant: SOLARGIK LTD, Jerusalem (IL)

(72) Inventors: Gil Kroyzer, Jerusalem (IL); Israel Kroizer, Jerusalem (IL); Morag Am Shallem, Jerusalem (IL); Joseph Schwarzbach, Jerusalem (IL)

(21) Appl. No.: 18/072,778

(22) Filed: Dec. 1, 2022

(51) Int. Cl. H02S 20/32

(52) U.S. Cl. CPC H02S 20/32

(57) ABSTRACT

A method of operating a solar energy system in the vicinity of one or more fixed structures comprises: periodically reorienting the plurality of PV modules to minimize an angular-dependent loss in power output for each respective successive sun angle during an unshaded period characterized by an absence of fixed-structure shading impinging on the respective pivot volumes, and orienting the plurality of PV modules to reduce a loss in power output due to shading by the one or more fixed structures during a shade period characterized by non-zero partial shading by the one or more fixed structures impinging on one or more of the respective pivot volumes.

### FIELD OF THE INVENTION

The present invention relates to solar energy systems and in particular to devices and methods for mitigating the extent and severity of power losses from partial shading of PV assemblies by nearby structures.

### BACKGROUND

Achieving a diversified low-carbon emissions energy economy has been limited by economic and technological limitations. Solar energy systems comprising photovoltaic (PV) arrays are commonly deployed to capture energy from both direct and diffuse (including reflected) solar irradiance.

PV arrays serve to generate electricity when solar illumination is incident upon the arrays. Generated electricity is typically fed into an electrical grid of the city/locality.

Sunlight collected by PV arrays is often categorized into two types: direct normal radiation (DNR), sometimes referred to as direct normal irradiation (DNI), and diffused irradiation, which when measured on a flat surface is equivalent to diffused horizontal irradiation (DHI) and, when the PV array is inclined, is called diffused tilted irradiation (DTI). Diffused irradiation can include reflected (albedo) irradiance, which is sometimes considered a separate, third type of solar radiation.

One way to significantly increase electrical generation obtained from PV arrays is to periodically pivot the PV panels of the PV arrays to orientations that face the sun to the extent possible, i.e., by ‘tracking’ the sun as closely as possible to maintain a normal vector to the incipient direct radiation. However, such tracking PV systems are sometimes deployed in the vicinity of buildings, or between buildings. When the panels are pivoted to face the sun in the mornings and late afternoons in hours when the height of the sun is at its minimum, the PV panels of the arrays can be partially shaded by the tops of the adjacent buildings. This partial shadowing can cause disproportionately high losses in power output.

### SUMMARY

The methods and systems disclosed herein relate to the mitigation of power output losses in PV arrays installed in the vicinity of fixed structures.

A method is disclosed, according to embodiments, for operating a solar energy system in the vicinity of one or more fixed structures. According to the method, the solar energy system comprises a plurality of photovoltaic (PV) modules and one or more motor assemblies configured to pivot the plurality of PV modules through respective pivot volumes. The method comprises: (a) during an unshaded period characterized by an absence of fixed-structure shading impinging on the respective pivot volumes, periodically reorienting the plurality of PV modules to minimize an angular-dependent loss in power output for each respective successive sun angle; and (b) during a shade period characterized by non-zero partial shading by the one or more fixed structures impinging on one or more of the respective pivot volumes, orienting the plurality of PV modules to reduce a loss in power output due to shading by the one or more fixed structures.

In some embodiments, it can be that the orienting during the shade period to reduce a loss in power output due to shading does not minimize the angular-dependent loss in power output. In some embodiments, it can be that the orienting during the shade period minimizes a combined loss in power output, i.e., the loss in power output that is due to a combination of the angular-dependent loss and the loss due to shading. In some embodiments, the angular-dependent loss can include a cosine loss. In some embodiments, the angular-dependent loss can include a transmission loss through a respective covering component of the PV modules.

In some embodiments, orienting the plurality of PV modules to reduce a loss in power output due to shading by the one or more fixed structures can be performed during two noncontiguous shade periods characterized by non-zero partial shading by the one or more fixed structures impinging on one or more of the respective pivot volumes.

In some embodiments, the one or more fixed structures can comprise a greenhouse.

According to embodiments of the invention, a solar energy system comprises: (a) a plurality of photovoltaic (PV) modules; (b) one or more motor assemblies; and (c) a control system configured to control the one or motor assemblies to pivot the plurality of PV modules through respective pivot volumes, wherein: (i) during an unshaded period characterized by an absence of fixed-structure shading impinging on the respective pivot volumes, the pivoting includes periodically reorienting the plurality of PV modules to minimize an angular-dependent loss in power output for each respective successive sun angle, and (ii) during a shade period characterized by non-zero partial shading by the one or more fixed structures impinging on one or more of the respective pivot volumes, the pivoting includes orienting the plurality of PV modules to reduce a loss in power output due to shading by a fixed structure.

In some embodiments, it can be that the orienting during the shade period to reduce a loss in power output due to shading does not minimize the angular-dependent loss in power output. In some embodiments, it can be that the orienting during the shade period minimizes a loss in power output due to a combination of the angular-dependent loss and the loss due to shading.

In some embodiments, the angular-dependent loss can include a cosine loss. In some embodiments, the angular-dependent loss can include a transmission loss through a respective covering component of the PV modules.

In some embodiments, the control system can be configured to control the one or motor assemblies to pivot the plurality of PV modules through respective pivot volumes during two noncontiguous shade periods characterized by non-zero partial shading by the fixed structure impinging on one or more of the respective pivot volumes.

In some embodiments, the one or more fixed structures can comprise a greenhouse.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a solar energy system, according to embodiments of the present invention.

FIG. 2 shows a schematic layout of selected components of a solar energy system according to embodiments of the present invention.

FIG. 3 shows a block diagram of a control system for a solar energy system, according to embodiments of the present invention.

FIGS. 4A,4B and 5 are schematic illustrations of greenhouses.

FIGS. 6 and 7 are schematic illustrations of PV arrays arranged between and in the vicinity of fixed structures, according to embodiments of the present invention.

FIG. 8 is a schematic illustration of a PV module experiencing partial shading due to a fixed structure, according to embodiments of the present invention.

FIG. 9 shows a graph showing exemplary power output losses due to partial shading.

FIG. 10 schematically illustrates a pivot volume of a PV panel, according to embodiments of the present invention.

FIGS. 11 and 12 schematically illustrate a pivot volume of a PV panel, respectively during an unshaded period and during a shaded period, according to embodiments of the present invention.

FIG. 13 is a schematic illustration of a PV panel pivoted to avoid experiencing partial shading due to a fixed structure, according to embodiments of the present invention.

FIG. 14 schematically illustrates an incidence angle of a PV panel.

FIGS. 15 and 16 show respective graphs of angular-dependent losses.

FIG. 17 shows a flowchart of a method for operating a solar energy system in the vicinity of one or more fixed structures, according to embodiments of the present invention.

FIG. 18 schematically illustrates a pivot volume of a PV panel, during two different shaded periods, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Embodiments disclosed herein relate to mitigating the output losses in photovoltaic (PV) energy systems caused by the partial shading of PV modules by fixed structures in the vicinity of the modules. The mitigation, in embodiments, is accomplished by reorienting, or pivoting, the PV modules away from a direct normal vector to incident direct radiation so to reduce or eliminate the shading. The mitigation of shading losses comes at the expense of increased angular-dependent optical losses such as so-called cosine losses and transmittance losses through the glass plates covering the PV panels. In some embodiments, the control system is configured to achieve a local optimization of the electrical output of the array of PV by minimizing the total combined losses, i.e., the losses from shading and the optical, angular-dependent losses. The more the PV panel is pivoted away from the sun-facing position, the greater the angular-dependent losses.

A ‘solar energy system’ as used herein means a system for generating electricity using an array of (PV) modules. A ‘PV energy system’ or ‘PV system is used interchangeably with ‘solar energy system.’ The system can include an inverter for converting the direct-current (DC) electricity generated by the PV modules to alternating current (AC) electricity, e.g., for delivery to an electricity grid.

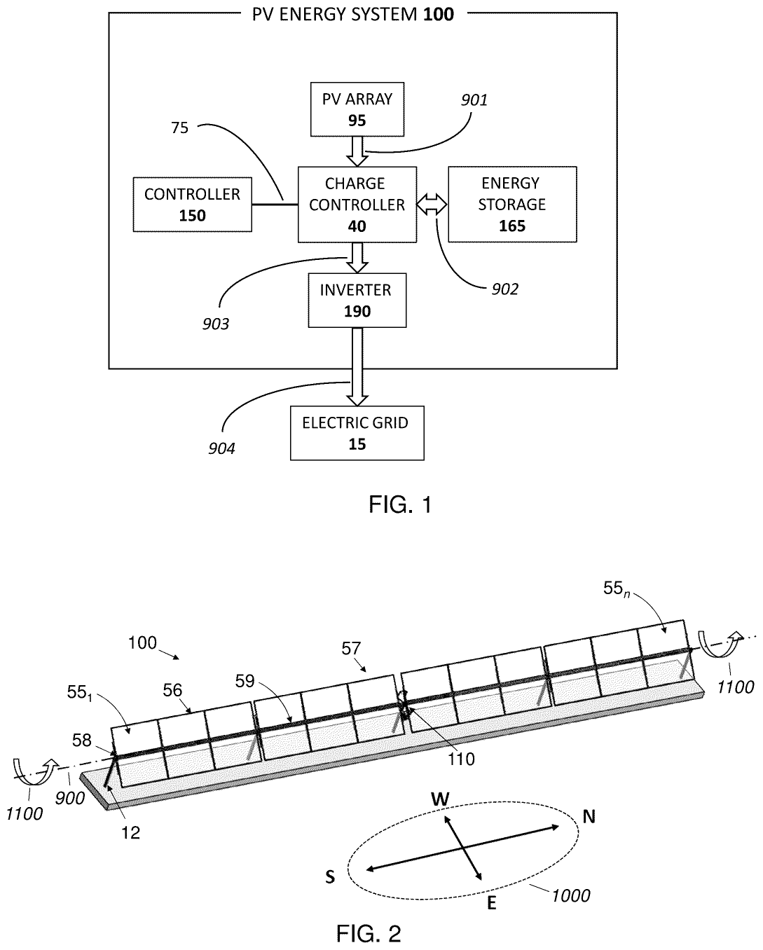

Referring now to the figures, and in particular to FIG. 1, a solar energy system 100 according to embodiments includes a PV array 95 comprising a plurality of PV modules 57 (shown in FIG. 2). In embodiments, the PV array 95 includes a tracking component, i.e., a solar tracker, for increasing cumulative electricity generated over the course of a period of time.

A solar tracker, or simply ‘tracker’, is an arrangement that changes the orientation of the PV panels so as to capture, i.e., convert, a higher proportion of the direct irradiance falling on the panels over the course of nearly any given period of time. Capture and conversion of the diffuse radiation component is largely unaffected by the tracking. A single-axis tracker is one that rotates PV panels around a single axis, usually from east to west over the course of a day around a north-south axis. A double-axis tracker is one that is designed to generally have the PV panels ‘face’ the sun directly at all times so as to capture and convert the entire amount of available direct irradiance. Some double-axis trackers operate using Euler angles and are not, strictly speaking, rotating the PV panels about two Cartesian axes, but the results are substantially the same. The embodiments disclosed herein are described in terms of single-axis tracking, but their application, mutatis mutandis, to double-axis tracking, is within the scope of the present invention.

The solar system 100 of FIG. 1 additionally includes an inverter 190 for conversion of DC electricity to AC. An inverter can include electronic circuitry, for example for synchronizing the phase, and for matching the voltage and frequency of the power output to those of the grid. The PV array typically has an output rating in kilowatts peak (kWp) which is the maximum DC power output rating for a given set of standard of environmental and operating conditions such as, e.g., temperature.

FIG. 1 further illustrates a non-limiting example of a power flow scheme for a solar energy system 100: power generated by the PV array 95 flows to a charge controller 40 as indicated by arrow 901. Two-way power flow takes place between the charge controller 40 and an energy storage device 165, as indicated by two-way arrow 902. Power from the PV array 95 and the energy storage device 165 flows through the charge controller 40 to the inverter 190, as indicated by arrow 903. The inverter 190 can deliver energy to the electric grid 15, as indicated by arrow 904.

Referring now to FIG. 2, a solar energy system 100 according to embodiments includes one or more PV modules 57. The PV module 57 includes an array of n PV panels 551 through 55», joined to a support subassembly 58. The support subassembly 58 includes an array of frames 56 for mounting the PV panels 55, and a central elongated member 59 to which the frames 56 are joined. The central elongated member 59 serves to transfer a torque to rotate the frames 56 as a unit together with the central elongated member 59 and the PV panels 55. The PV module 57 is rotated about a central longitudinal axis indicated in FIG. 2 by dashed line 900, and the rotation is schematically represented by arrows 1100. The central elongated member 59 is pivotably supported by ground supports 12. As shown by axes 1000, the panels are facing generally east, indicating that FIG. 2 shows a morning orientation. The tracking of the PV module 57 is shown as being east-west tracking as is the case in the vast majority of current installations of PV modules, but the principles disclosed here are equally applicable to north-south tracking systems, mutatis mutandis. A drive system 110 supported by a ground support 12 is provided to pivoting the PV modules 57 to desired orientations. An example of a suitable drive system 110 is disclosed in co-pending U.S. patent application Ser. No. 17/845,196, titled “Solar energy system and geared drive system”, filed on Jun. 21, 2022, and incorporated herein by reference in its entirety.

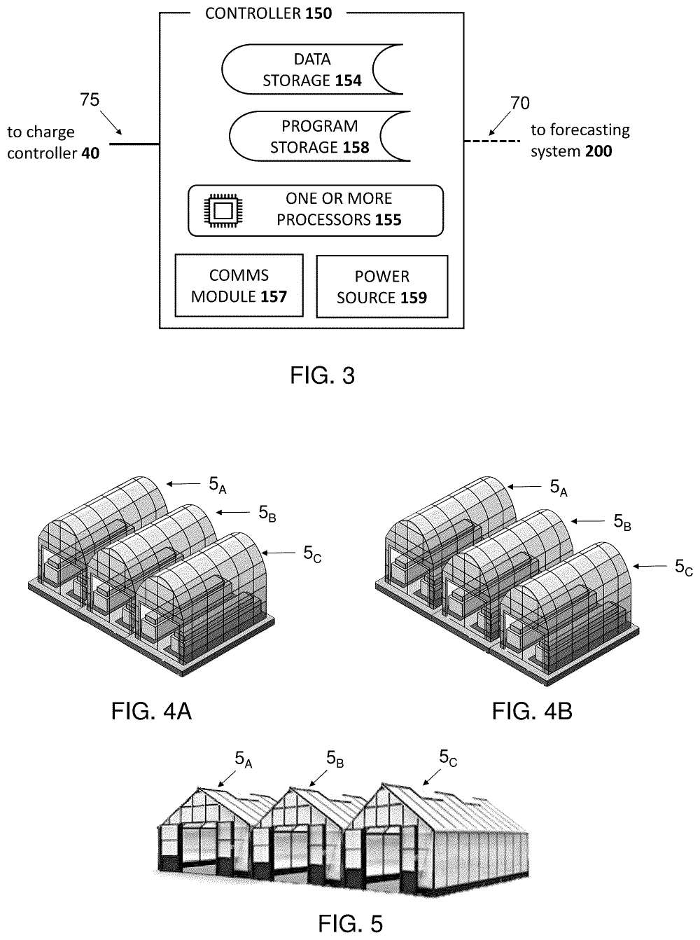

A control system 150 for a solar energy system 100, according to embodiments, is illustrated schematically in FIG. 3 to show selected components. The exemplary control system 150 of FIG. 3 includes one or more computer processors 155, a computer-readable storage medium 158, a communications module 157, and a power source 159. The computer-readable storage medium 158 can include transient and/or transient storage, and can include one or more storage units, all in accordance with desired functionality and design choices. The storage 158 can be used for any one or more of: storing program instructions, in firmware and/or software, for execution by the one or more processors 155 of the control system 150. In embodiments, the stored program instructions include program instructions for operating a solar energy system 100. The program instructions include instructions to carry out some or all of the methods and method steps. Execution of any of the program instructions by the one or more processors 155 causes the performance of the methods and method steps. Data storage 154, if separate from storage 158, can be provided for historical data, e.g., actual irradiance and/or forecast values, e.g., forecasted irradiance values, and other data related to the operation of the solar energy system 100 such as, for example, information about fixed structures in the vicinity of PV modules. In some embodiments, the two storage modules 154, 158 form a single module. The communications module 159 is configured to establish communications links, e.g., via communication arrangements 70 with a forecasting system 200, and with the charge controller 40 via communications arrangements 75. In some embodiments, a control system 150 does not necessarily include all of the components shown in FIG. 3. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as CAN bus (Controller Area Network, Fieldbus, FireWire, HyperTransport and InfiniBand.

In embodiments, PV arrays can be deployed in the vicinity of fixed structures, including without limitation atop and between such structures. In the non-limiting examples of FIGS. 4A, 4B and 5, a number of different greenhouse configurations are shown. Greenhouses are often characterized by being unsuitable for bearing rooftop PV systems for a number of reasons, including, and not exhaustively: to avoid shading the plants growing within the greenhouses, or because the covering material of the greenhouses may include translucent cloth or plastic sheeting that is structurally unsuitable for bearing the load of PV modules. It can therefore be desirable to deploy PV systems—and especially added-value tracking PV systems—between greenhouses, where they can be supported either by the ground or by structural frames of the greenhouses. In some implementations, the structural frames are fortified for bear the load of the tracking PV systems, and in other implementations the structural frames of existing greenhouses or of new greenhouses are adequate for bearing the loads. FIG. 4A illustrates a non-limiting example of three rounded-roof greenhouse buildings 5 sharing common walls, while FIG. 4B illustrates a non-limiting example in which similar buildings 5 spaced apart. FIG. 5 illustrates a non-limiting example of three slanted-roof greenhouse buildings 5, again sharing common walls like the greenhouse buildings 5 of FIG. 4A.

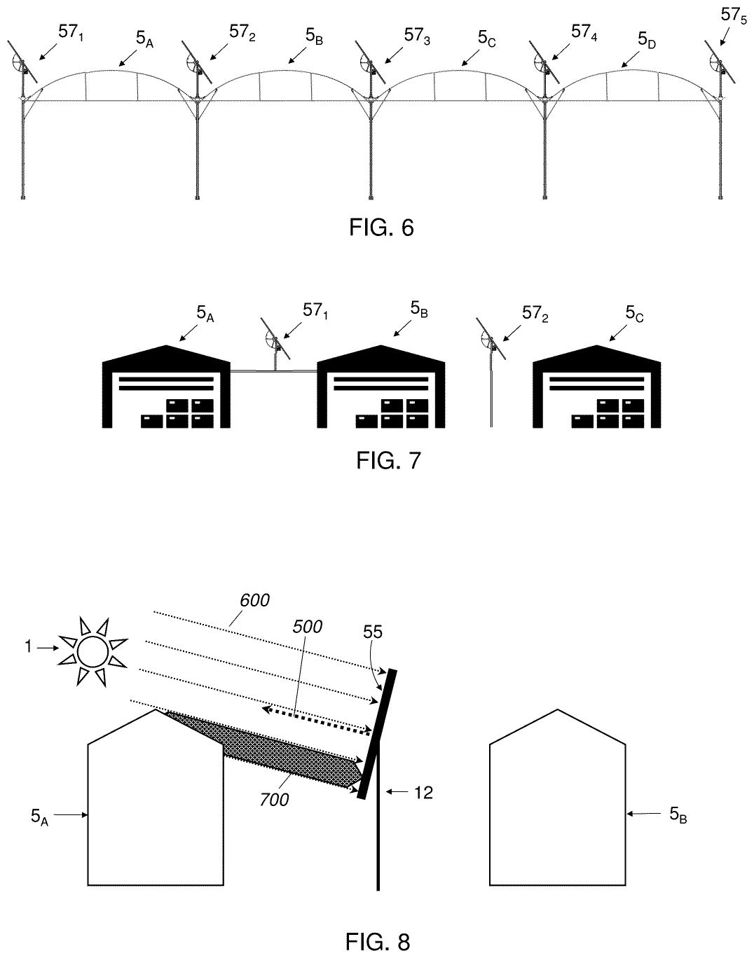

FIGS. 6 and 7 illustrate illustrative, non-limiting examples of deploying PV modules 57 with sun-tracking capabilities in the vicinity of fixed structures. We note that in FIGS. 6 and 7, the PV systems are shown in an end view (or, equivalently, a cross-sectional view) that shows the orientation of the pivotable PV modules without regard to the length of the array. This view is used throughout the figures (except for FIG. 2) when showing PV panels, modules and systems.

FIG. 6 illustrates, in a cross-sectional view, an exemplary string of greenhouse buildings 5 of the type shown in FIG. 4A. The PV modules can be seen to be supported by the structural frames of the common walls shared by adjacent buildings 5, or by the external walls of end-buildings. FIG. 7 shows adaptation of a different type of slant-roofed structure 5: spaced-apart light-industrial buildings. While such buildings can often be adapted to bear the load of fixed-angle PV systems, in many cases the roof can be unsuitable for other reasons. In some cases, deploying tracking PV systems between the buildings may be desirable in terms of financial return. In FIG. 7, a first tracking system of PV modules 57₁ is installed on a structure supported by both adjacent buildings 5, while a second system of PV modules 57₂ is supported on the ground. The foregoing examples illustrate PV systems deployed in the vicinity of fixed structures; in other examples any manner of structure and/or erection of the PV system can be provided.

Referring now to FIG. 8, a tracking PV module 55 is deployed in the vicinity of fixed structures 5_{A} and 5_{B}. The PV panels 55 are rotated to face the sun 1, as shown by the arrow 500 indicating the normal vector, i.e., normal to the active face of the PV panel 55. This represents a typical operating mode of a tracking PV system, in which the panels 55 are periodically reoriented to minimize angular-dependent optical losses. In FIG. 8, however, the direct normal radiation, indicated by arrow 600, is partly blocked by the roof of the fixed structure 5_{A}, creating partial shading on the sun-facing PV panel 55, indicated in FIG. 8 by the fraction 700 of direct radiation 600 lost to shading. In some implementations, partial shading of PV panels can cause loss of electrical power output that is disproportionate to the area actually shaded.

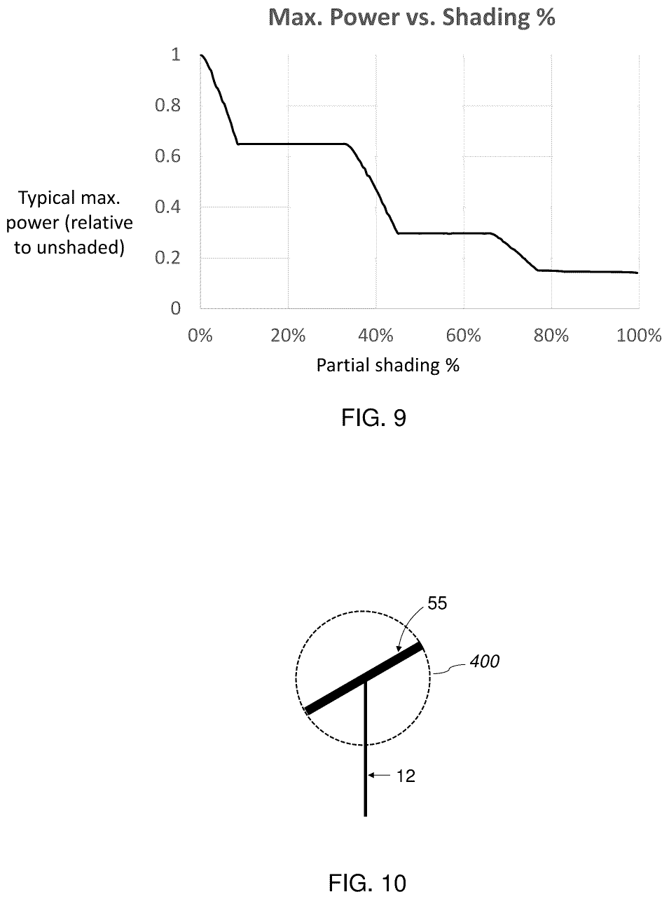

As is known in the art, the loss of electrical power output from partial shading can be partly mitigated by the use of one or more bypass diodes in the PV modules. FIG. 9 shows an illustrative example of a power output curve as a function of shading fraction, for a generic PV module having six rows of cells and 3 bypass diodes. Each point on the curve represents a maximum power figure (across the voltage range of the module) for each percentage of shading fraction. The maximum power figure is equal to the max. power at each shading fraction divided by the unshaded maximum power. It can be seen that throughout most of the range of shading fraction, the proportion of lost electrical power output is higher than the shading fraction.

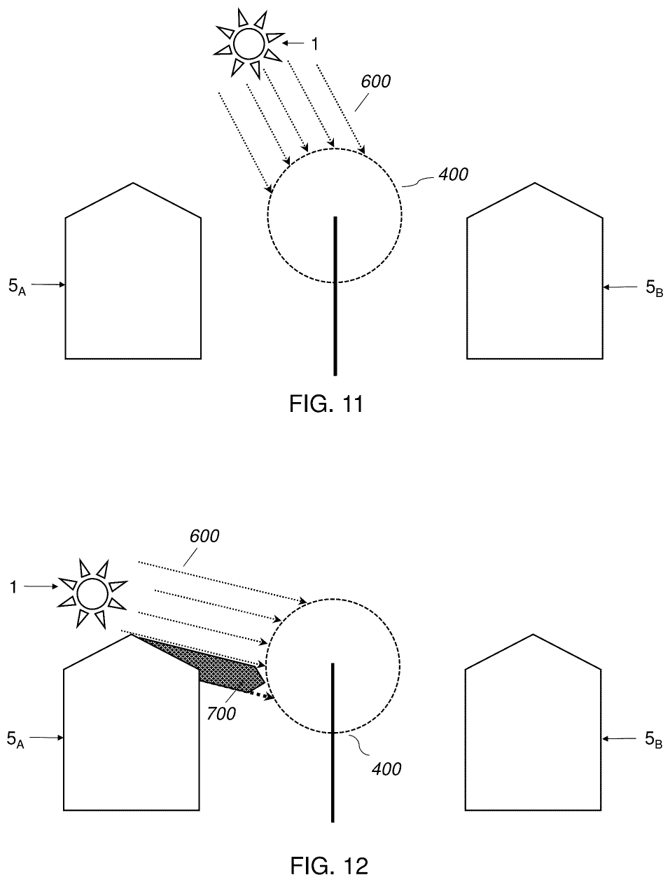

According to embodiments, the partial shading of PV modules can be mitigated by pivoting the PV modules to an orientation where they are no longer in shadow, or where the amount of shading is reduced. When determining whether and when a nearby fixed structure 5 will block a portion of incident direct radiation so as to cast shade on part of a sun-tracking PV module, it can be useful, according to embodiments, to determine a pivot volume of the PV modules. Using the pivot volume as a reference, it is possible to determine when the panel will undergo partial shading without first having to calculate the orientation angle of the PV panel at that time. As shown in FIG. 10, a pivot volume is a volume 400 that describes the volume through which a PV panel 55 can pivot. In the non-limiting example shown in FIG. 10, the pivot volume 400 is a cylindrical solid and thus is shown as a circle in an end view or cross-sectional view. In other examples, the pivot volume 400 can be a cylindrical volume or an irregular solid having a non-circular cross-section, depending on how the PV panels pivot relative to a mechanical pivot axis such as a torque tube 59. This is further illustrated in FIGS. 11 and 12. FIG. 11 illustrates an exemplary unshaded period characterized by an absence of either of the buildings 5 casting a shadow on the pivot volume 400. FIG. 12, in contrast, is based on the partly-shaded PV panel 55 of FIG. 8, and thus illustrates a shade period characterized by non-zero partial shading by building 5_{A} impinging on the pivot volume 400.

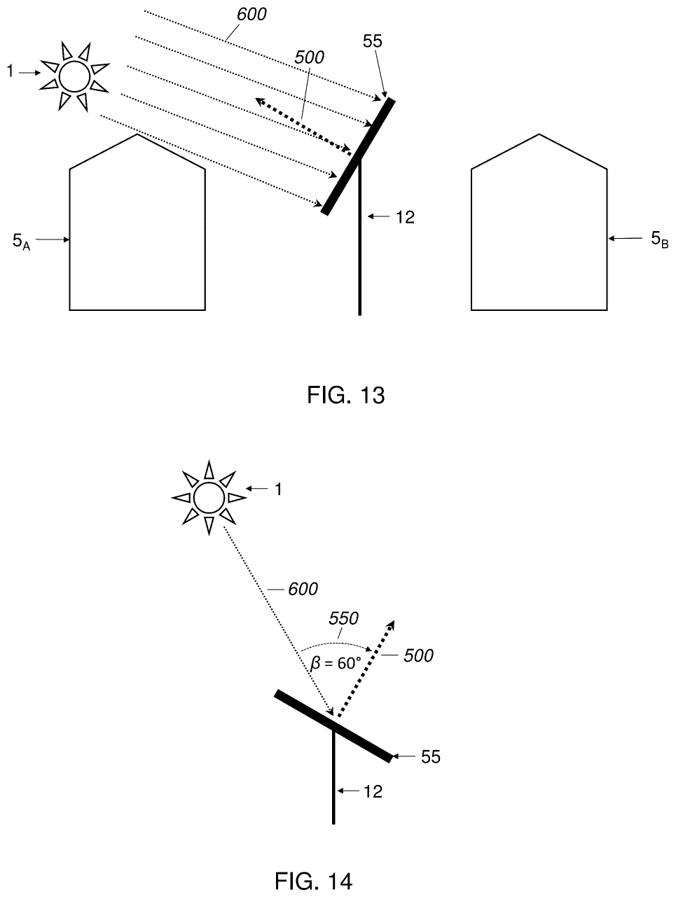

According to embodiments, the partial shading of PV modules can be mitigated by pivoting the PV modules to an orientation where they are no longer in shadow, or where the amount of shading is reduced. FIG. 13 illustrates an example of pivoting PV modules to an orientation where they are no longer in shadow. The PV system of FIG. 13 is similar to that of FIG. 8, which showed the PV panels 55 being partly shadowed by building 5_{A}. In FIG. 13, the PV panels 55 are rotated clockwise (from the perspective of the figures) to an orientation in which they are no longer shaded by building 55_{A}. In tradeoff, the direct radiation 600 reaches the surface of the PV panels 55 at an angle that is not a right angle. This can be seen, for example, by noting that the normal vector 500 of the panels has rotated clockwise, together with with the panels themselves, to form an angle to the direct normal radiation. The angle between the normal vector and the actual vector in which the direct radiation strikes the face of the PV panel is called the ‘incidence angle’. FIG. 14 illustrates the ‘incidence angle’ concept more clearly, showing 8 as the ‘incidence angle’ between direct radiation 600 incident on the PV panel and a normal vector 500 of the PV panel.

FIG. 13 is a ‘snapshot’ which represents the system at a specific moment in time. In an example in which FIG. 13 illustrates an early morning scenario and the sun is low in the east, the PV panels 55 (and the respective pivot volume 400) will be clear of the shade within a few minutes or less than an hour, and can then track the sun directly, i.e., continually align the normal vector 500 with the incident direction radiation to form zero or close-to-zero incidence angle (at least in the plane visible in FIG. 13), for most of the rest of the day. In contradistinction, in an example in which FIG. 13 is showing a late-afternoon scenario and the sun is low in the west, the PV panels will have to be rotated clockwise more and more as the proportion of partial shading grows, and the incidence angle will continue to grow as well, until the sun dips behind building 5_{A} from the perspective of the PV panels 55. The non-limiting example of FIG. 13 and the foregoing discussion could be misconstrued to understand that the panels 55 are pivoted to strictly eliminate the partial shading by the building 5. Nevertheless, in some embodiments, the panels 55 are pivoted to reduce the shading, but not necessarily to eliminate it.

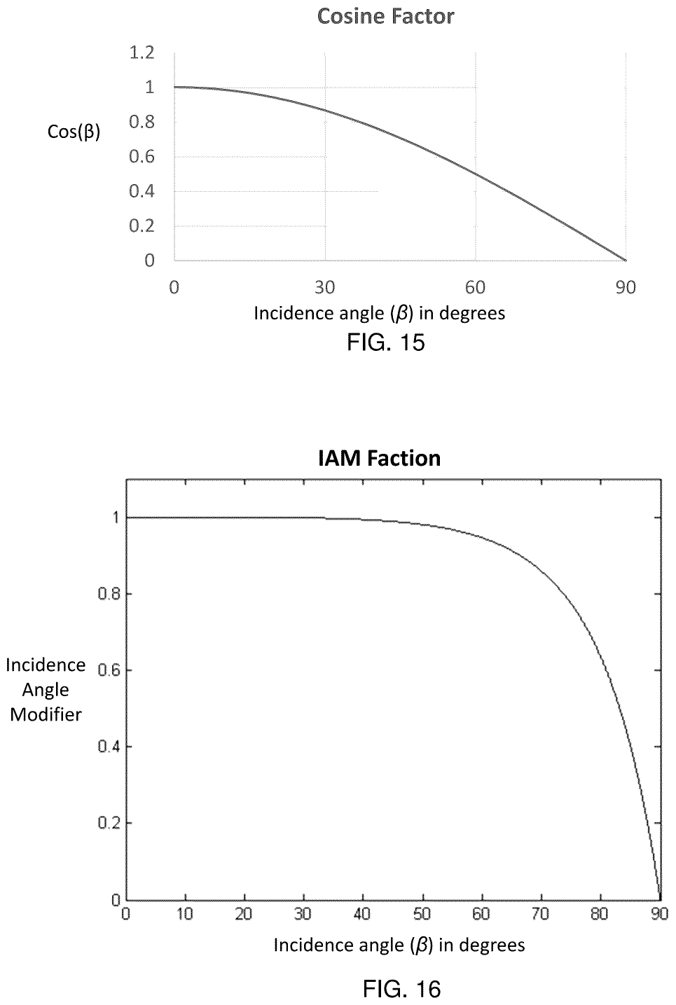

In embodiments, the pivoting of the PV panels to an orientation in which the shading is mitigated replaces the shading losses with optical losses dependent upon the incidence angle β. A first type of angular-dependent optical loss is the cosine loss, so called because the amount of direct normal irradiance actually incident on the active face of a PV panel 55 is proportional to the cosine of the incidence angle β. FIG. 15 shows a plot of a cosine factor, i.e., cos(β) as a function of incidence angle β. For example, when β=0°, i.e., the PV panel faces the sun directly, the cosine is equal to 1, and the cosine loss is therefore equal to zero. When β=60°, as is shown in FIG. 14, the cosine factor is 0.5, which is the cosine of 60°. The cosine loss, i.e., 1-cos(β), is also 0.5 because 1-0.5=0.5. A cosine loss of 0.5 means that half of the incident direct normal radiation is lost, i.e., not received by the PV modules; for example, if direct normal radiation of 800 W/m² is available a set of PV panels oriented at 0° incidence angle, only 400 W/m² is available to the same panel when oriented at a 60° incidence angle.

A second type of angular-dependent optical loss is the IAM loss, where IAM stands for ‘incidence angle modifier’. The IAM is a factor that accounts for loss in transmittance of light through the glass cover layer of a PV panel as a function of incidence angle. The IAM for any incidence angle β is generally calculated as transmittance of the glass at an incidence angle β divided by the transmittance at a normal angle, i.e., at an incidence angle β of 0°. In some embodiments, a generic IAM curve, i.e., generic to different PV-panel manufacturers, is used in calculating IAM-related losses. For example, the generic curve shown in FIG. 16 was developed by Sandia National Laboratories in the United States based on Snell's law, which deals with refraction, and one the Beer-Bouguer-Lambert law, which deals with attenuation of radiation within a medium. In some embodiments, a manufacturer-specific IAM curve is used, i.e., a curve received from a manufacturer of PV panels. In some embodiments, a specific IAM curve is developed through empirical measurements. The loss, i.e., power output reduction, due to the IAM is (1-IAM) times the power output at β=0°. A comparison of FIGS. 15 and 16 shows that the IAM loss is substantially less than the cosine loss for most of the range of pivot, e.g., from 0° to well above 80°, and in some embodiments, the cosine loss alone is used for first-order approximations and local optimization of the mitigation of the partial shading.

A third type of angular-dependent optical loss is the power output reduction due to panel soiling, which is also dependent on the amount of surface soiling on the face of the PV panel.

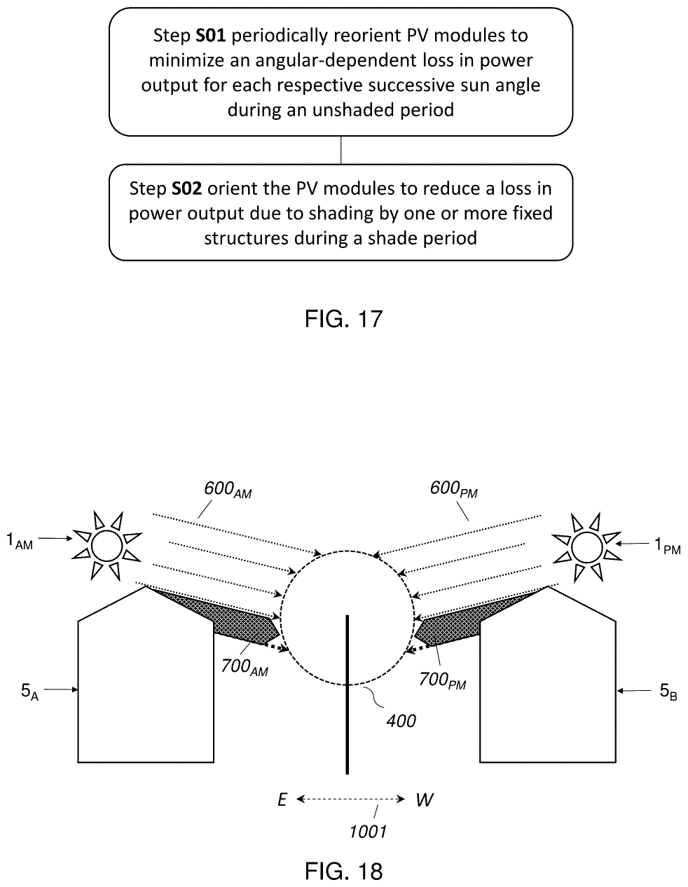

Referring now to FIG. 17, a method is disclosed for operating a solar energy system or PV energy system 100, e.g., one of the systems 100 of FIGS. 1 and 2. According to the method, the solar energy system 100 comprises a plurality of photovoltaic (PV) modules 57 and one or more motor assemblies configured to pivot the plurality of PV modules 57 through respective pivot volumes 400. As illustrated by the flow chart in FIG. 17, the method comprises at least the two method steps S01 and S02.

Step S01 includes periodically reorienting the plurality of PV modules 57 to minimize an angular-dependent loss in power output for each respective successive sun angle. Step S01 is carried out during an unshaded period characterized by an absence of fixed-structure shading impinging on the respective pivot volumes 400. In some embodiments, the angular-dependent loss includes a cosine loss. In some embodiments, the angular-dependent loss includes a transmission loss through a respective covering component of the PV modules. In some embodiments, the angular-dependent loss includes an optical loss due to soiling.

Step S02 includes orienting the plurality of PV modules 57 to reduce a loss in power output due to shading by the one or more fixed structures 5. Step S02 is carried out during a shade period characterized by non-zero partial shading by the one or more fixed structures 5 (e.g., one or more greenhouses or industrial buildings) impinging on one or more of the respective pivot volumes 400. In some embodiments, orienting the plurality of PV modules 57 during the shade period to reduce a loss in power output due to shading does not minimize the angular-dependent loss in power output; the angular-dependent loss in power output can increase when the PV modules 57 are oriented to reduce a loss in power output due to shading. In some embodiments, the orienting during the shade period minimizes the combined loss in power output due to a combination of the angular-dependent loss, which can increase in Step S02, and the loss due to shading, which can decrease Step S02.

In some embodiments, Step S02 is performed during two noncontiguous shade periods characterized by non-zero partial shading by the one or more fixed structures impinging on one or more of the respective pivot volumes. Referring now to FIG. 18, a system similar to that shown in FIG. 12 is shown schematically to undergo partial shading in two non-contiguous periods. The east and west directions in FIG. 18 are indicated by arrow 1001. With the morning sun 1_{AM} in the east, building 5_{A} blocks direction normal radiation 600_{AM} to create partial shading 700_{AM} on the pivot volume 400. Building 5_{B} blocks direction normal radiation 600_{PM} from the ‘afternoon sun’ 1_{PM} in the west to create partial shading 700_{PM} on the pivot volume 400.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1-7. (canceled)

8. A solar energy system, comprising:
a. a plurality of photovoltaic (PV) modules;
b. one or more motor assemblies; and
c. a control system configured to control the one or motor assemblies to pivot the plurality of PV modules through respective pivot volumes, wherein:
i. during an unshaded period characterized by an absence of fixed-structure shading impinging on the respective pivot volumes, the pivoting includes periodically reorienting the plurality of PV modules to minimize an angular-dependent loss in power output for each respective successive sun angle, and
ii. during a shade period characterized by non-zero partial shading by the one or more fixed structures impinging on one or more of the respective pivot volumes, the pivoting includes orienting the plurality of PV modules to reduce a loss in power output due to shading by a fixed structure,
wherein the orienting during the shade period minimizes a loss in power output due to a combination of the angular-dependent loss and the loss due to shading.

9. The solar energy system of claim 8, wherein the orienting during the shade period to reduce a loss in power output due to shading does not minimize the angular-dependent loss in power output.

10. (canceled)

11. The solar energy system of claim 8, wherein the angular-dependent loss includes a cosine loss.

12. The solar energy system of claim 8, wherein the angular-dependent loss includes a transmission loss through a respective covering component of the PV modules.

13. The solar energy system of claim 8, wherein the control system is configured to control the one or motor assemblies to pivot the plurality of PV modules through respective pivot volumes during two noncontiguous shade periods characterized by non-zero partial shading by the fixed structure impinging on one or more of the respective pivot volumes.

14. The solar energy system of claim 8, wherein the one or more fixed structures comprise a greenhouse.

15. A method of operating the solar system of claim 8, the method comprising:
a. during the unshaded period, periodically reorienting the plurality of PV modules to minimize an angular-dependent loss in power output for each respective successive sun angle; and
b. during the shade period, orienting the plurality of PV modules, the orienting being effective (i) to reduce a loss in power output due to shading by the one or more fixed structures, and (ii) to minimize a loss in power output due to a combination of the angular-dependent loss and the loss due to shading.

16. The method of claim 15, wherein the orienting during the shade period does not minimize the angular-dependent loss in power output.

17. The method of claim 15, wherein the orienting during the shade period does not eliminate the loss due to shading.

18. The method of claim 16, performed during two noncontiguous shade periods characterized by non-zero partial shading by the one or more fixed structures impinging on one or more of the respective pivot volumes.
